(19) United States
(12) Patent Application Publication
(10) Pub. No.: US 2018/0160484 A1
(43) Pub. Date: Jun. 7, 2018

(54) Vehicle Protection System

(71) Applicants: Ester Bryant, Northglenn, CO (US); Michael Bryant, Northglenn, CO (US)

(72) Inventors: Ester Bryant, Northglenn, CO (US); Michael Bryant, Northglenn, CO (US)

(21) Appl. No.: 15/367,555

(22) Filed: Dec. 2, 2016

(51) Int. Cl. H05B 3/34; B60J 11/06; H02J 7/35

(52) U.S. Cl. CPC H05B 3/34; H02J 7/35; B60J 11/06

(57) ABSTRACT

A vehicle protection system to inhibit precipitating from freezing on a vehicle includes a vehicle that has a top side. A blanket is selectively positioned on the vehicle to inhibit precipitation from contacting the top side of the vehicle. A heating unit is coupled to the blanket and the heating unit is in thermal communication with the blanket. Moreover, the heating unit heats the blanket when the heating unit is turned on to melt the precipitation when the precipitation falls on the blanket.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to protection devices and more particularly pertains to a new protection device for inhibiting frozen precipitation from collection on a vehicle.

### BRIEF SUMMARY OF THE INVENTION

An embodiment of the disclosure meets the needs presented above by generally comprising a vehicle that has a top side. A blanket is selectively positioned on the vehicle to inhibit precipitation from contacting the top side of the vehicle. A heating unit is coupled to the blanket and the heating unit is in thermal communication with the blanket. Moreover, the heating unit heats the blanket when the heating unit is turned on to melt the precipitation when the precipitation falls on the blanket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a blanket of a vehicle protection system according to an embodiment of the disclosure.

FIG. 2 is a perspective in-use view of an embodiment of the disclosure.

FIG. 3 is a top view of a blanket of an embodiment of the disclosure.

FIG. 4 is a cross sectional view taken along line 4-4 of FIG. 3 of an embodiment of the disclosure.

FIG. 5 is a detail view taken from circle 5 of FIG. 4 of an embodiment of the disclosure.

FIG. 6 is a schematic view of an embodiment of the disclosure.

### DETAILED DESCRIPTION OF THE INVENTION

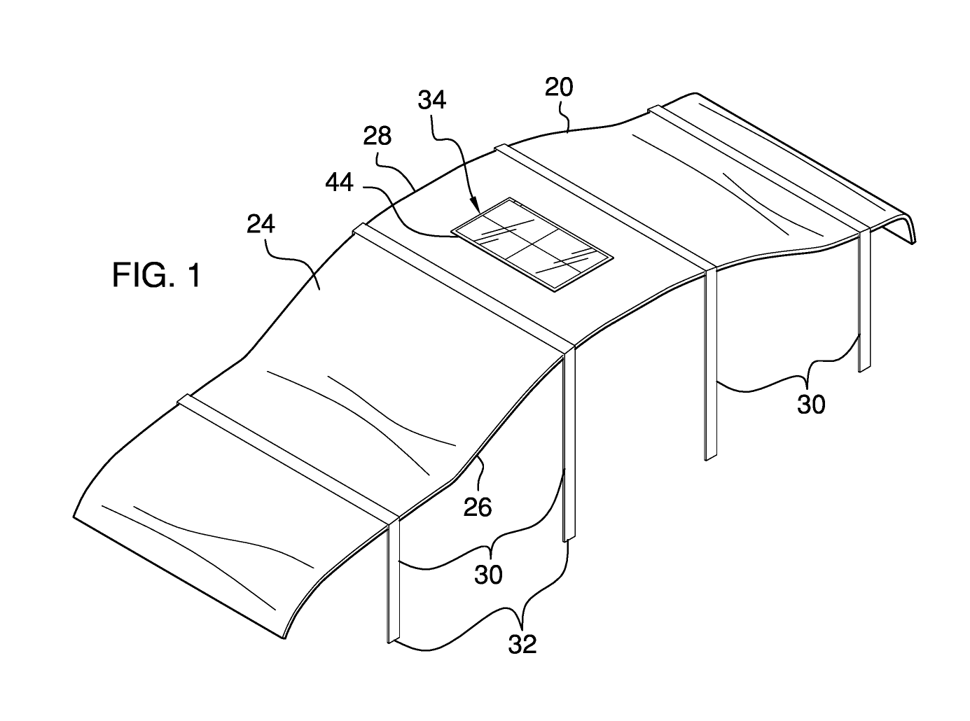

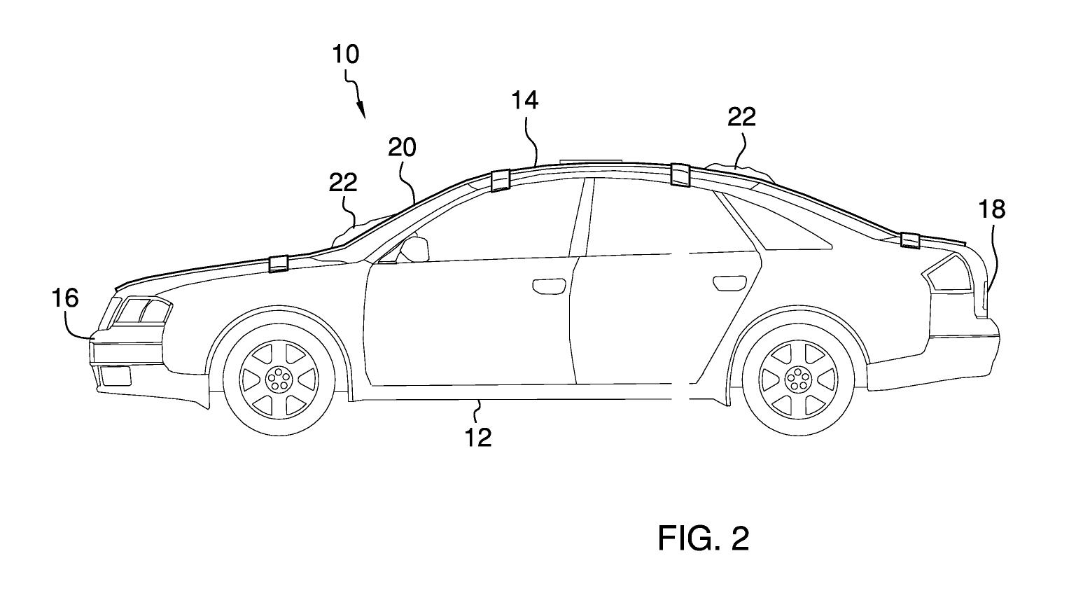

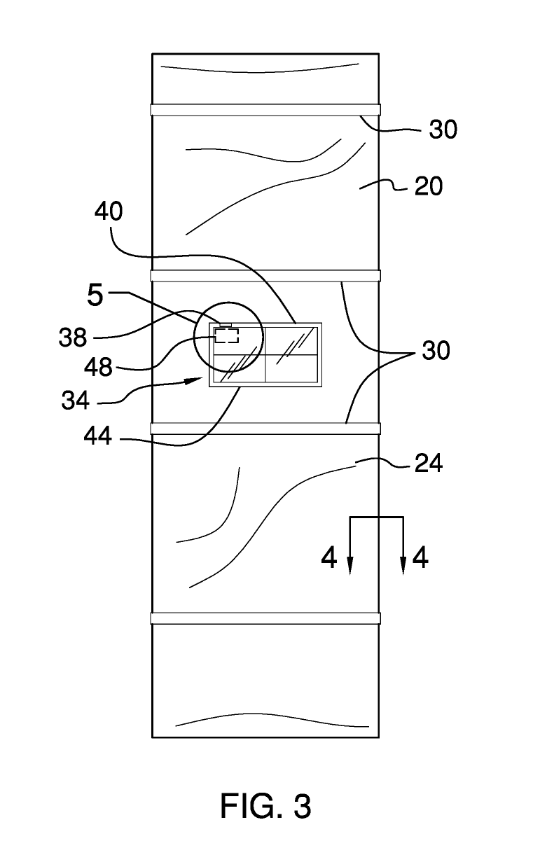

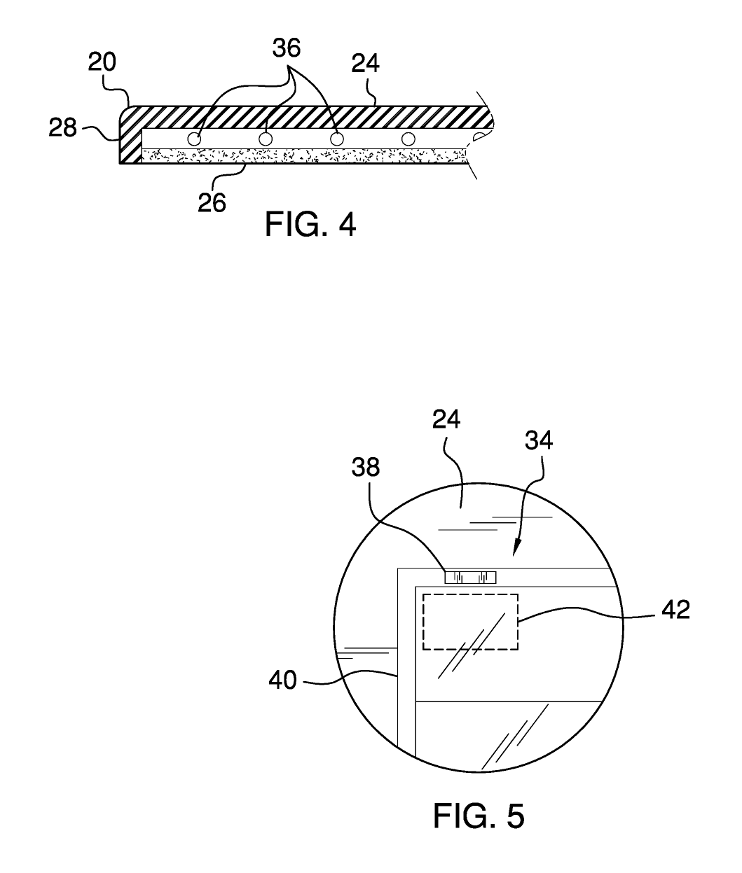

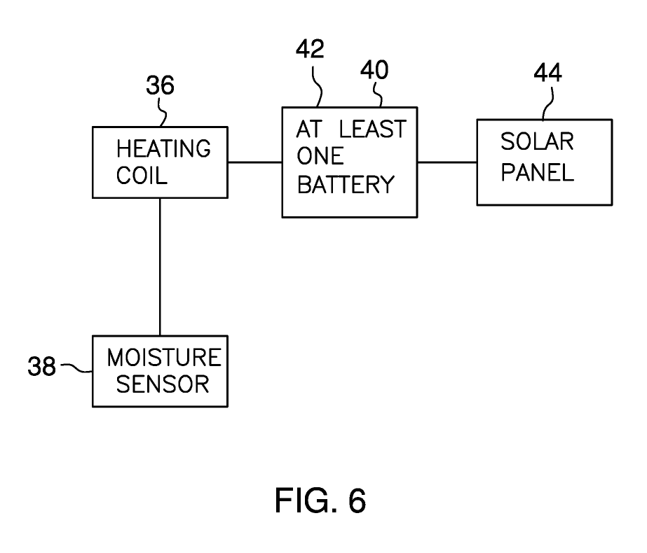

With reference now to the drawings, and in particular to FIGS. 1 through 6 thereof, a new protection device embodying the principles and concepts of an embodiment of the disclosure and generally designated by the reference numeral 10 will be described.

As best illustrated in FIGS. 1 through 6, the vehicle protection system 10 generally comprises a vehicle 12 that has a top side 14, a front side 16 and a back side 18. The vehicle 12 may be a passenger vehicle 12 or the like. A blanket 20 is provided and the blanket 20 is selectively positioned on the vehicle 12. The blanket 20 covers the top side 14 to inhibit precipitation 22 from contacting the top side 14 of the vehicle 12. Moreover, the blanket 20 extends between the front side 16 and the back side 18 of the vehicle 12. The precipitation 22 may be snow, freezing rain, sleet or any other form of frozen precipitation 22.

The blanket 20 has a top side 24, a bottom side 26 and a peripheral edge 28 extending therebetween. The bottom side 26 abuts the vehicle 12 when the blanket 20 is positioned on the vehicle 12. The top side 24 is comprised of a fluid impermeable material such as plastic, rubber or any other deformable, fluid impermeable material. The bottom side 26 is comprised of a non abrasive material such as fleece, cotton or other deformable, non abrasive material. Thus, the bottom side 26 is inhibited from scratching the top side 14 of the vehicle 12 when the blanket 20 is positioned on the vehicle 12.

A plurality of mating members 30 is provided and each of the mating members 30 is coupled to the blanket 20. Each of the mating members 30 extends away from the peripheral edge 28 of the blanket 20. The mating members 30 are spaced apart from each other and are distributed around the blanket 20. Each of the mating members 30 releasably engages the vehicle 12 when the blanket 20 is positioned on the vehicle 12 to retain the blanket 20 on the vehicle 12.

Each of the mating members 30 has a distal end 32 with respect to the blanket 20 and the distal end 32 corresponding to each mating member 30 is matable to the distal end 32 of an associated mating member 30. A plurality of couplers may be provided and each of the couplers may be attached to the distal end 32 of an associated one of the mating members 30. The couplers may engage each other to releas ably attach the mating members 30 to each other. The mating members 30 may be extended through windows of the vehicle 12 and beneath a hood of the vehicle 12. In this way the mating members 30 inhibit the blanket 20 from being blown from the vehicle 12.

A heating unit 34 is provided and the heating unit 34 is coupled to the blanket 20. The heating unit 34 is in thermal communication with the blanket 20 such that the heating unit 34 heats the blanket 20 when the heating unit 34 is turned on. In this way the heating unit 34 inhibits the precipitation 22 from freezing on the blanket 12.

The heating unit 34 comprises a heating coil 36 that is positioned between the top side 14 and the bottom side 26 of the blanket 20. The heating coil 36 is distributed along the top side 14 of the blanket 20 and the heating coil 36 is in thermal communication with the top side 14 of the blanket 20. The heating coil 36 may be an electric heating coil 36 with an operational temperature ranging between approximately 60 degrees Fahrenheit and 80 degrees Fahrenheit.

A moisture sensor 38 is provided and the moisture sensor 38 is coupled to the top side 14 of the blanket 20. The moisture sensor 38 detects the precipitation 22 when the precipitation 22 falls on the moisture sensor 38. The moisture sensor 38 is electrically coupled to the heating coil 36 such and the moisture sensor 38 turns the heating coil 36 on when the moisture sensor 38 detects the precipitation 22. The moisture sensor 38 may be an electronic moisture sensor 38 or the like.

A power supply 40 is provided and the power supply 40 is coupled to the blanket 20. The power supply 40 is electrically coupled to the heating coil 36. The power supply 40 comprises at least one battery 42 that is coupled to the blanket 20. The at least one battery 42 is electrically coupled to the heating coil 36. A solar panel 44 is coupled to the top side 14 of the blanket 20 to be exposed to sunlight when the blanket 20 is positioned on the vehicle 12. The solar panel 44 is electrically coupled to the at least one battery 42 such that the solar panel 44 charges the at least one battery 42. The solar panel 44 may comprise a solar panel 44 of any conventional design.

In use, the blanket 20 is positioned on the top side 14 of the vehicle 12 during winter months or whenever frozen precipitation 22 is expected. The mating members 30 are positioned to engage the vehicle 12 and the mating members 30 are coupled to each other. In this way the blanket 20 is retained on the vehicle 12. The solar panel 44 charges the battery 42 when the solar panel 44 is exposed to sunlight. The moisture sensor 38 turns the heating coil 36 on when the moisture sensor 38 detects the precipitation 22. Thus, the heating coil 36 heats the top side 14 of the blanket 20 to ensure the precipitation 22 on the blanket 12 does not freeze. The blanket 20 is removed from the vehicle 12 when the vehicle 12 is driven.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle protection system comprising:
a vehicle having a top side;
a blanket being selectively positioned on said vehicle such that said blanket covers said top side wherein said blanket is configured to inhibit precipitation from contacting said top side of said vehicle, said blanket having a top side, a bottom side and a peripheral edge extending therebetween, said bottom side abutting said vehicle when said blanket is positioned on said vehicle, said top side being comprised of a fluid impermeable material, said bottom side being comprised of a non abrasive material such that said bottom side is inhibited from scratching said top side of said vehicle when said blanket is positioned on said vehicle;
a heating unit being coupled to said blanket, said heating unit being in thermal communication with said blanket such that said heating unit heats said blanket when said heating unit is turned on wherein said heating unit is configured to melt the precipitation when the precipitation falls on said blanket; and
a plurality of mating members, each of said mating members being an elongated strap having a medial portion extending over said top side of said blanket and a pair of outer portions extending outwardly from opposite sides of said peripheral edge of said blanket, each of said outer portions extending perpendicularly away from said peripheral edge of said blanket, said mating members being parallel to each other and spaced apart from each other along a length of said blanket, each of said mating members being configured to releasably engage said blanket to said vehicle when said blanket is positioned on said vehicle to retain said blanket on said vehicle.

2. (canceled)

3. (canceled)

4. The system according to claim 1, wherein said heating unit comprises a heating coil being positioned between said top side and said bottom side of said blanket, said heating coil being distributed along said top side, said heating coil being in thermal communication with said top side of said blanket.

5. The system according to claim 4, further comprising a moisture sensor being coupled to said top side of said blanket wherein said moisture sensor is configured to detect the precipitation, said moisture sensor being electrically coupled to said heating coil such that said moisture sensor turns said heating coil on when said moisture sensor detects the precipitation.

6. The system according to claim 4, further comprising a power supply being coupled to said blanket, said power supply being electrically coupled to said heating coil.

7. The system according to claim 6, wherein said power supply comprises at least one battery being coupled to said blanket, said at least one battery being electrically coupled to said heating coil.

8. The system according to claim 7, further comprising a solar panel being coupled to said top side of said blanket wherein said solar panel is configured to be exposed to sunlight when said blanket is positioned on said vehicle, said solar panel being electrically coupled to said at least one battery such that said solar panel charges said at least one battery.

9. A vehicle protection system comprising:
a vehicle having a top side;
a blanket being selectively positioned on said vehicle such that said blanket covers said top side wherein said blanket is configured to inhibit precipitation from contacting said top side of said vehicle, said blanket having a top side, a bottom side and a peripheral edge extending therebetween, said bottom side abutting said vehicle when said blanket is positioned on said vehicle, said top side being comprised of a fluid impermeable material, said bottom side being comprised of a non abrasive material such that said bottom side is inhibited from scratching said top side of said vehicle when said blanket is positioned on said vehicle;
a plurality of mating members, each of said mating members being an elongated strap having a medial portion extending over said top side of said blanket and a pair of outer portions extending outwardly from opposite sides of said peripheral edge of said blanket, each of said outer portions extending perpendicularly away from said peripheral edge of said blanket, said mating members being parallel to each other and spaced apart from each other along a length of said blanket, each of said mating members being configured to releasably engage said blanket to said vehicle when said blanket is positioned on said vehicle to retain said blanket on said vehicle; and
a heating unit being coupled to said blanket, said heating unit being in thermal communication with said blanket such that said heating unit heats said blanket when said heating unit is turned on wherein said heating unit is configured to melt the snow when the snow falls on said blanket, said heating unit comprising:
a heating coil being positioned between said top side and said bottom side of said blanket, said heating coil being distributed along said top side of said blanket, said heating coil being in thermal communication with said top side of said blanket,
a moisture sensor being coupled to said top side of said blanket wherein said moisture sensor is configured to detect the snow, said moisture sensor being electrically coupled to said heating coil such that said moisture sensor turns said heating coil on when said moisture sensor detects snow, and
a power supply being coupled to said blanket, said power supply being electrically coupled to said heating coil, said power supply comprising:
at least one battery being coupled to said blanket, said at least one battery being electrically coupled to said heating coil, and
a solar panel being coupled to said top side of said blanket wherein said solar panel is configured to be exposed to sunlight when said blanket is positioned on said vehicle, said solar panel being electrically coupled to said at least one battery such that said solar panel charges said at least one battery.
